(19) United States
(12) Patent Application Publication
(10) Pub. No.: US 2010/0070446 A1
(43) Pub. Date: Mar. 18, 2010

(54) SYSTEM AND METHOD FOR REPRESENTING INCONSISTENTLY FORMATTED DATA SETS

(76) Inventor: Mark Philip Shipman, West Hartford, CT (US)

Correspondence Address: BUCKLEY, MASCHOFF & TALWALKAR LLC, 50 LOCUST AVENUE, NEW CANAAN, CT, 06840, US

(21) Appl. No.: 12/209,437

(22) Filed: Sep. 12, 2008

(51) Int. Cl. G06N 5/02

(52) U.S. Cl. 706/46

(57) ABSTRACT

Two or more data sets, arranged in mutually inconsistent formats, are stored in a computer. Software is applied to each data set to discover and generate a topology for a respective Bayesian Belief Network for each of the data sets. The resulting individual constituent Bayesian Belief Networks are combined to produce a combined Bayesian Belief Network. The combined Bayesian Belief Network represents a virtual data set that does not exist but which stands in for a combination of the original data sets. The combined Bayesian Belief Network is a convenient representation that may be analyzed to investigate causality relationships among all of the variables in the constituent data sets.

### FIELD

The present invention relates to computer systems and more particularly to computerized representations of complex data sets.

### BACKGROUND

In a co-pending and commonly assigned U.S. patent application (filed Jul. 29, 2008 and assigned Ser. No. 12/181,463, entitled “Centrally Maintained Portable Driving Score”), it is proposed to base insurance underwriting decisions at least partially on data gathered telematically, as well as on data accumulated in one or more state Departments of Motor Vehicles. As is understood by those who are skilled in the art, “telematics” refers to collection of data automatically via sensors installed in motor vehicles.

It may be advisable to apply statistical analysis to the DMV data and telematics data in order to reach conclusions about what patterns of data are likely to indicate that prospective insureds pose relatively high or low risks. However, such statistical analysis may be made difficult by the large quantities of data that may be involved, and by inconsistencies in the formats of data sets received from various sources.

### SUMMARY

A method for generating a suggested insurance decision is provided in accordance with aspects of the present invention. The method includes storing a first data set in a computer. The first data set contains data related to public driving records. For example, the data in the first data set may be stored and/or generated in one or more state Departments of Motor Vehicles.

The method further includes storing a second data set in the computer. The second data set contains data gathered telematically with respect to a first plurality of drivers. The second data set has a different format from the first data set.

In addition, the method includes processing the first data set with the computer to generate a first Bayesian Belief Network that represents the first data set. Further, the method includes processing the second data set with the computer to generate a second Bayesian Belief Network that represents the second data set.

The method also includes manually combining the first and second Bayesian Belief Networks to form a combined Bayesian Belief Network that represents a virtual data set, which encompasses at least a portion of each of the first and second data sets.

Additionally, the method includes receiving input with respect to a proposed or current insured and generating a signal indicative of a suggested insurance decision with respect to the proposed insured. The suggested insurance decision is based at least in part on (a) the received input with respect to the proposed or current insured, and (b) the combined Bayesian Belief Network.

As used herein and in the appended claims, the term “insurance decision” includes at least one of underwriting an insurance policy, offering an insurance policy, renewing an insurance policy, adjusting an insurance policy and pricing an insurance policy.

The combined Bayesian Belief Network makes it feasible to represent and statistically characterize a collection of data that originated from different sources and in different formats. This combined representation may produce analytical results that are more robust than could be obtained from just one set of data alone. Moreover, the combined Bayesian Belief Network may be a highly efficient way of representing quantities of data that would be too large for practical handling without representation.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram of a system provided according to aspects of the present invention.

FIG. 2 is a block diagram representation of a data modeling computer shown as part of the system of FIG. 1.

FIG. 3 is a block diagram representation of a typical computer that may be operated by an insurance underwriter and that may be part of the system of FIG. 1.

FIG. 4 is a flow chart that illustrates a process that may be performed in the system of FIG. 1 in accordance with aspects of the present invention.

FIG. 5 is a flow chart that illustrates details of the process of FIG. 4.

Each of FIGS. 6-8 shows a simplified example of a Bayesian Belief Network that represents a respective data set to be statistically analyzed by the process of FIGS. 4 and 5.

FIG. 9 shows a simplified example of a Bayesian Belief Network formed in accordance with aspects of the present invention by combining the Bayesian Belief Networks of FIGS. 6-8.

FIGS. 10-14 are simulated example Bayesian Belief Networks that are useful for illustrating example techniques for producing combined Bayesian Belief Networks in accordance with aspects of the present invention.

### DETAILED DESCRIPTION

In general, and for the purposes of introducing concepts of embodiments of the present invention, a number of different data sets that are received from different sources and in different formats may be virtually combined by being represented by a combined Bayesian Belief Network that represents statistical attributes of the virtually combined data set. The combined Bayesian Belief Network is assembled manually from individual Bayesian Belief Networks that are each derived by conventional software from a respective one of the original, inconsistently formatted data sets.

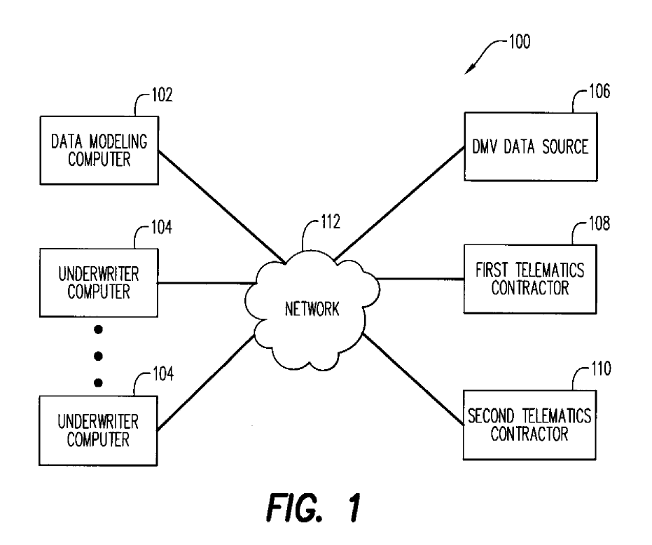

FIG. 1 is a block diagram of a system 100 provided according to aspects of the present invention. The system 100 includes a data modeling computer 102 that is described in more detail below. In some embodiments, the data modeling computer 102 may be operated by a research employee of an insurance company.

The system 100 further includes a number of other computers 104 that are operated by employees of the insurance company who are responsible for, e.g., underwriting insurance policies that cover individual motor vehicles and/or fleets of motor vehicles.

A further component of the system 100 is a source 106 of data generated and/or collected by one or more state Departments of Motor Vehicles. Among other information, the data provided by the data source 106 may include driver demographic information, and information about moving violations of which drivers have been convicted. The data from data source 106 may also include information regarding accidents in which the drivers have been involved.

The system 100 may also include telematics companies 108 and 110. The telematics companies 108 and 110 may be under contract with the above-mentioned insurance company to provide data (raw or preferably summarized) gathered by the telematics companies 108 and 110 with respect to the driving behavior of various populations of drivers. Examples of telematics companies are the companies known as DriveCam, GreenRoad, IVOX and WebTech.

The system 100 is also shown as including a data network 112. In practice, the data network 112 may include more than one network, including for example an intranet (not shown apart from network 112) operated by the insurance company and interconnecting the insurance company computers 102 and 104. Other portions of the data network 112 may be constituted by one or more public data networks (e.g., the Internet) by which data may be downloaded from the DMV data source 106 and/or the telematics companies 108, 110 to one or more of the insurance company computers 102, 104.

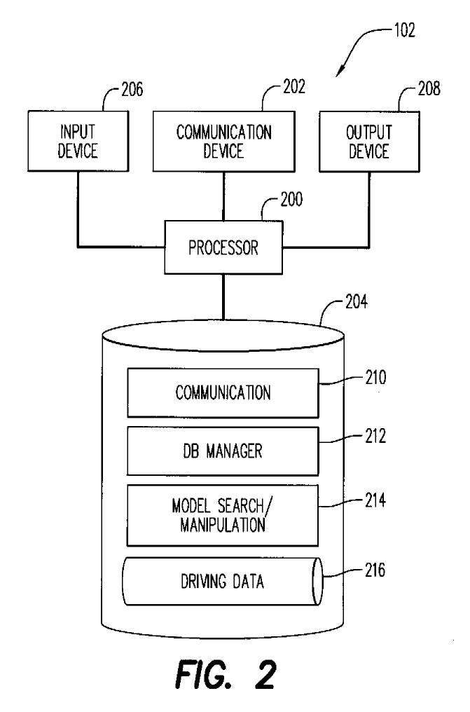

FIG. 2 is a block diagram that illustrates an example embodiment of the data modeling computer 102. In its hardware aspects the data modeling computer 102 may be entirely conventional, but may be programmed to operate in accordance with aspects of the present invention. In a practical embodiment, the data modeling computer 102 may be constituted by a conventional personal computer programmed by software that implements functionality as described herein.

As depicted, the data modeling computer 102 includes a computer processor 200 operatively coupled to, and in communication with, a communication device 202, a storage device 204, one or more input devices 206 and one or more output devices 208. Communication device 202 may be used to facilitate communication with, for example, other devices such as the underwriter computers 104, the DMV data source 106 and/or the computers operated by the telematics companies 108, 110. The input device(s) 206 may comprise, for example, a keyboard, a keypad, a mouse or other pointing device, a microphone, knob or a switch, an infra-red (IR) port, a docking station, a scanner, and/or a touch screen. The input device(s) 206 may be used, for example, to enter information such as input from a user of the data modeling computer 102. Output device 208 may comprise, for example, a display (e.g., a display screen) a speaker, and/or a printer.

Storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. As used herein and in the appended claims, a “memory” refers to any one or more of the components of the storage device 204, including removable storage media.

Storage device 204 stores one or more programs for controlling processor 200. Processor 200 performs instructions of the programs, and thereby operates in accordance with the present invention. In some embodiments, the programs may include a program 210 that controls the processor 200 to allow for data communication between the data modeling computer 102 and other devices. The programs may also include one or more conventional database manager programs, indicated at 212.

Still further, the programs may include a data modeling program (indicated at 214) that may be operable to produce the above-mentioned Bayesian Belief Networks. An example of such a data modeling program is Tetrad IV, publicly available under the auspices of Carnegie Mellon University. Tetrad IV, as discussed further below, provides functionality for automatically discovering the topology of a Bayesian Belief Network that represents an input data set, and also provides a workspace that permits a user to manipulate Bayesian Belief Networks generated automatically by the software. Although Tetrad IV is conventional, a novel manner of utilizing the program is proposed herein.

Data collected with respect to drivers and/or driving behaviors may also be stored in the storage device 204, as indicated at 216. The driving data may be processed by the programs stored in the storage device 204.

There may also be stored in the storage device 204 other software, such as one or more conventional operating systems, device drivers, etc.

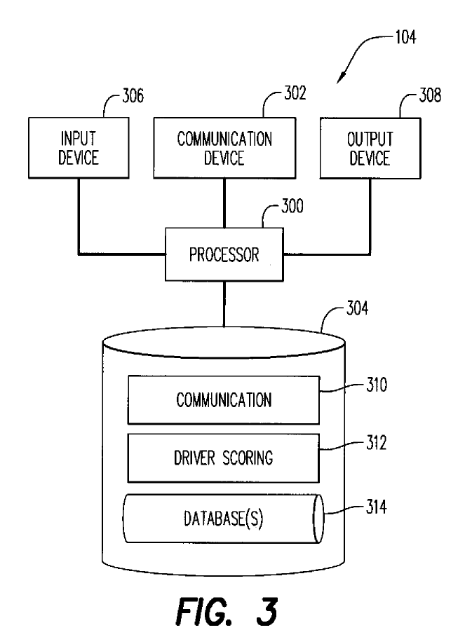

FIG. 3 is a block diagram of a typical one of the underwriter computers 104 shown in FIG. 1. Like the data modeling computer 102, the underwriter computer 104 may be constituted in its hardware aspects by a conventional personal computer. Thus the underwriter computer 104 may include the same hardware components arranged in the same or a similar fashion as described above in regard to the data modeling computer 102. Nevertheless, the hardware makeup of the underwriter computer 104 will now be briefly summarized.

As depicted in FIG. 3, the underwriter computer 104 includes a computer processor 300 operatively coupled to, and in communication with, a communication device 302, a storage device 304, one or more input devices 306 and one or more output devices 308. As in the case of the data modeling computer 102, the storage device 304 of the underwriter computer 104 stores software program instructions that control operation of the processor 300 of the underwriter computer 104 and hence control operation of the underwriter computer 104. These software program instructions may include a conventional communications program 310 and an application program 312 which utilizes a data model provided by the data modeling computer 102 to rate prospective individual insured drivers and/or driver employees of prospective insured organizations for underwriting purposes.

Reference numeral 314 in FIG. 3 indicates one or more databases that are stored in the storage device 304 and that contain data operated on by the programs which control the underwriter computer 104.

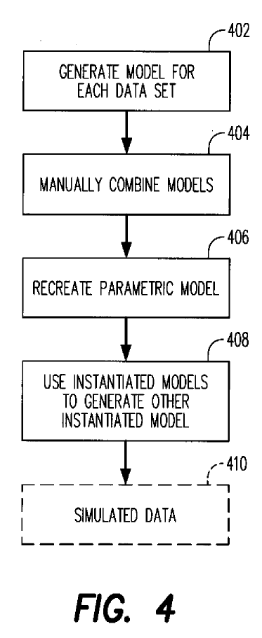

FIG. 4 is a high-level flow chart that illustrates a process performed by the system 100 in accordance with aspects of the present invention. As will be seen, the process of FIG. 4 may be performed primarily by the data modeling computer 102. In a preferred embodiment, the process of FIG. 4 may include generating a data model by operating the above-mentioned Tetrad IV software program in a novel manner.

At 402 in FIG. 4, the data modeling computer 102 is operated so as to generate a respective data model for each of a number of different data sets. As will be seen, the data model to be generated for each data set may be a Bayesian Belief Network. As is known to those who are skilled in the art, a Bayesian Belief Network is a probabilistic graphical model that represents a set of variables and their probabilistic independencies. More formally, a Bayesian Belief Network is defined as a pair (E, V) of edges E and vertices V. A directed edge from a vertex A to a vertex B represents that B is statistically dependent upon A. The vertices of a Bayesian Belief Network may alternatively be referred to as “nodes”, and the edges may be referred to as “arcs”. Simplified example Bayesian Belief Networks are illustrated in FIGS. 6-9 and will be discussed further below.

The different data sets for which Bayesian Belief Networks are generated in step 402 may be received from different sources and may be in different formats from each other. For example, each of the data sets may include one or more variables that are not present in some or all of the other data sets. The number of variables in each data set may vary substantially from one data set to the other.

In one proposed embodiment of the present invention, three different data sets may each be processed to produce a Bayesian Belief Network for the respective data set. One of the data sets may be received by the data modeling computer 102 from data source 106 (FIG. 1) and may contain data generated and/or stored by one or more state Departments of Motor Vehicles. For example, the first data set may contain data from the California DMV.

A second one of the data sets may be received by the data modeling computer 102 from the first telematics company 108 under a contract between the first telematics company and the above-mentioned insurance company. The second data set may contain data collected by the first telematics company with respect to a large number of drivers via sensors installed in the drivers' vehicles and monitored by the first telematics company. The second data set may contain raw telematics data and/or summaries or categorizations of raw data. In one embodiment, the first telematics company 108 may be the company known as WebTech.

The third one of the data sets may be received by the data modeling computer 102 from the second telematics company 110 under a contract between the second telematics company and the above-mentioned insurance company. The third data set may contain data collected by the second telematics company with respect to another large group of drivers via sensors installed in the vehicles of the other drivers and monitored by the second telematics company. The third data set also may contain raw telematics data and/or summaries or categorizations of raw data. In one embodiment, the second telematics company 110 may be the company known as IVOX.

The group of drivers covered by the third data set may partially overlap with the group of drivers covered by the second data set. Alternatively, the two groups of drivers may be completely different, i.e., with no overlap in membership between the two groups.

Each of the data sets may contain data relating to thousands, or even hundreds of thousands of drivers.

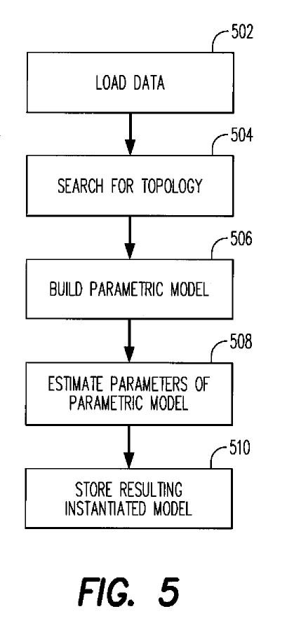

FIG. 5 is a flow chart that provides details of step 402 in FIG. 4. Referring to FIG. 5, at 502 one of the data sets is loaded (stored) into the data modeling computer 102. At 504, the above-mentioned Tetrad IV software program is executed in the data modeling computer 102 in a conventional manner to search for a Bayesian Belief Network topology that appropriately represents the data set loaded at 502. Tetrad IV implements a number of different known algorithms for searching for the Bayesian Belief Network topology, In general the search may start with the most general possible graph—i.e., a graph that is fully connected and undirected. The search may then gradually apply constraints based on d-separation until the most general graph is determined that is consistent with the interdependencies among the variables. (As is known to those who are skilled in the art, d-separation means that two variables that share the same parent are independent given the parent, and a variable is independent of a grandchild given the child.) The resulting general consistent graph is then converted to a directed acyclic graph (DAG) based on likelihood relationships indicated by the data and the principle of a minimum description length.

At 506, the software builds a parametric model based on the DAG produced at 504. Then, at 508, the parameters are estimated based on the probability distribution function at each vertex in the DAG to produce an instantiated model. At step 510, the instantiated model is stored.

The process of FIG. 5 is performed with respect to each data set that is to be combined with one or more other data sets. In one embodiment, the process of FIG. 5 is applied to the three data sets referred to above, resulting in three instantiated models, each of which is based on a respective Bayesian Belief Network. The instantiated model for each data set may be considered a condensed representation of the data in the data set.

Each of FIGS. 6-8 shows a simplified example of a Bayesian Belief Network that represents one of the three data sets that were statistically analyzed by the process of FIG. 5. In practice, for the types of data sets referred to herein, the search process implemented by Tetrad IV may result in a DAG having 10, 20 or 30 nodes, or more, as well as 10 or more arcs providing connections among the nodes. However, to simplify and clarify the presentation of key aspects of the invention, the simplified DAGs shown in FIGS. 6-8 are presented instead of actual DAGs. One slightly simplified example of a Bayesian Belief Network derived by Tetrad IV from a data set from WebTech is illustrated in FIG. 6A of the above-mentioned commonly-assigned patent application.

(All of the disclosure of said commonly-assigned patent application is incorporated herein by reference.) It is well within the abilities of those who are skilled in the art to operate the Tetrad IV software on actual data sets that are commercially available to arrive at actual Bayesian Belief Networks of the kind illustrated in simplified form in FIGS. 6-8.

FIG. 6, then, shows a Bayesian Belief Network 600, which in simplified form is representative of a Bayesian Belief Network derived from one of the three data sets. It will be observed that the Bayesian Belief Network 600 has four nodes, namely node 602 corresponding to the age of the driver, node 604 corresponding to whether the driver is a student, node 606 corresponding to the marital status of the driver, and node 608 corresponding to whether the driver has been convicted of a moving violation. The Bayesian Belief Network 600 further includes a directed arc 610 from node 604 to node 602, a directed arc 612 from node 606 to node 602 and a directed arc 614 from node 602 to node 608.

FIG. 7 shows a Bayesian Belief Network 700, which in simplified form is representative of a Bayesian Belief Network derived from a second one of the three data sets. The Bayesian Belief Network 700 has three nodes: A node 702 corresponding to the age of the driver, a node 704 corresponding to whether the driver tends to drive at higher-risk times of day, and a node 706 corresponding to whether the data indicates that the driver is prone to higher-risk maneuvering of his/her vehicle. The Bayesian Belief Network 700 also includes a directed arc 708 from node 702 to node 704 and a directed arc 710 from node 702 to node 706.

FIG. 8 shows a Bayesian Belief Network 800, which in simplified form is representative of a Bayesian Belief Network derived from the third of the three data sets. The nodes of the Bayesian Belief Network 800 are node 802, corresponding to whether the driver was convicted of a moving violation, node 804, corresponding to whether the driver was involved in an accident resulting in a claim for bodily injury, and node 806, corresponding to whether the driver was involved in an accident for which the driver's insurer paid a claim. The Bayesian Belief Network 800 also includes a directed arc 808 from node 804 to node 806, a directed arc 810 from node 804 to node 802, and a directed arc 812 from node 806 to node 802.

Referring again to FIG. 4, step 404 follows step 402. At step 404 an operator of the data modeling computer 102 manually combines together the Bayesian Belief Networks derived from the three data sets to produce a combined Bayesian Belief Network. The manual combination of the constituent Bayesian Belief Networks may proceed in a number of different ways. For example, if two of the constituent Bayesian Belief Networks share a node, the two constituent Bayesian Belief Networks may be joined at the common node. Alternatively, the user may have knowledge of the subject represented by the data that may lead the user to know or believe that there is a dependency relationship between a variable in one of the data sets and a variable in another one of the data sets. In that case, the user may draw a directed arc from the node that corresponds to the second variable in one of the constituent Bayesian Belief Networks to the node that corresponds to the first variable in another of the constituent Bayesian Belief Networks. Either or both of these techniques may be employed once or more than once to join together a given pair of the constituent Bayesian Belief Networks. If more than two Bayesian Belief Networks are to be formed into the combined Bayesian Belief Network, it may be the case that two of the constituent Bayesian Belief Networks may be connected only via one or more others of the constituent Bayesian Belief Networks.

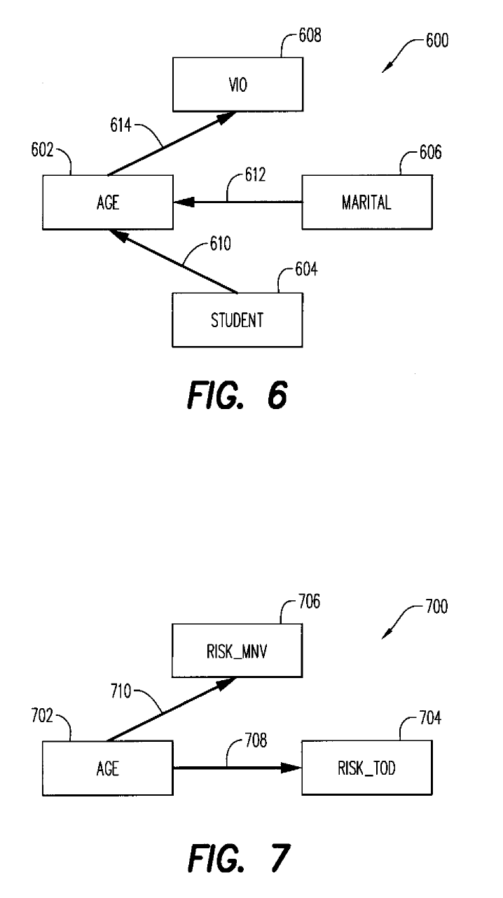

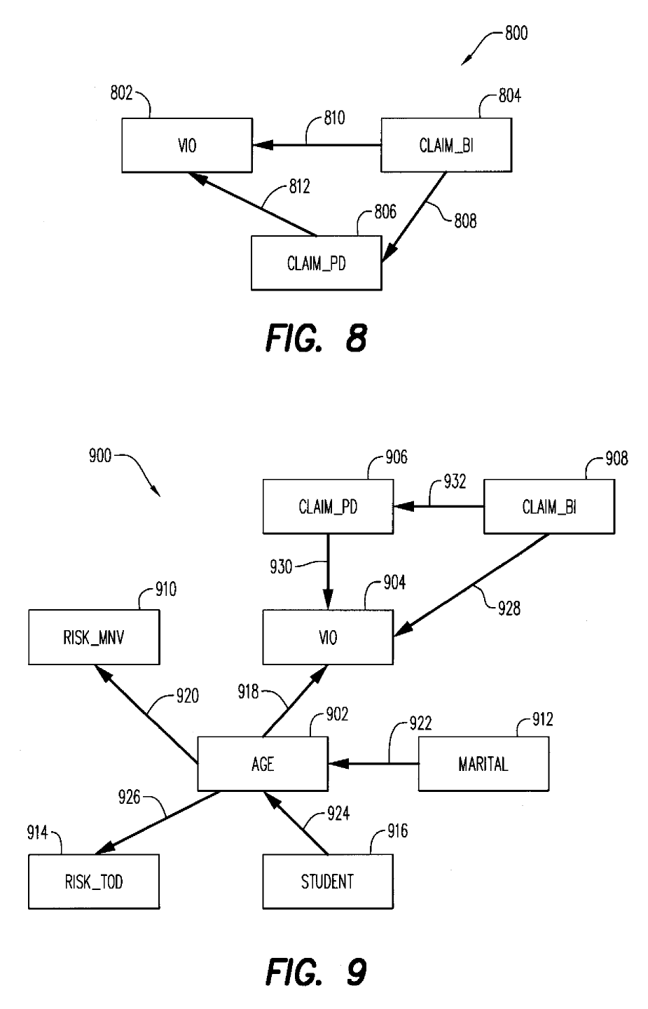

FIG. 9 is an example combined Bayesian Belief Network 900 formed from the constituent Bayesian Belief Networks shown in FIGS. 6-8. In this particular simplified example, the Bayesian Belief Network 600 of FIG. 6 and the Bayesian Belief Network 700 of FIG. 7 have been joined at their common node shown at 602 in FIG. 6, at 702 in FIG. 7 and at 902 in FIG. 9. In addition, the Bayesian Belief Network 600 of FIG. 6 and the Bayesian Belief Network 800 of FIG. 8 have been joined at their common node shown at 608 in FIG. 6, at 802 in FIG. 8, and at 904 in FIG. 9.

In the combined Bayesian Belief Network 900 shown in FIG. 9, node 906 corresponds to node 806 in FIG. 8, node 908 corresponds to node 804 in FIG. 8, node 910 corresponds to node 706 in FIG. 7, node 912 corresponds to node 606 in FIG. 6, node 914 corresponds to node 704 in FIG. 7, and node 916 corresponds to node 604 in FIG. 6. Moreover, in the Bayesian Belief Network 900, arc 918 corresponds to arc 614 in FIG. 6, arc 920 corresponds to arc 710 in FIG. 7, arc 922 corresponds to arc 612 in FIG. 6, arc 924 corresponds to arc 610 in FIG. 6, arc 926 corresponds to arc 708 in FIG. 7, arc 928 corresponds to arc 810 in FIG. 8, arc 930 corresponds to arc 812 in FIG. 8, and arc 932 corresponds to arc 808 in FIG. 8.

Let it now be assumed that the Bayesian Belief Network 600 of FIG. 6 did not include node 608. In that case, and assuming that the user had prior knowledge or belief that a driver's likelihood to be convicted of a moving violation was dependent on his/her age, then the user may still arrive at the combined Bayesian Belief Network topology illustrated in FIG. 9 by drawing arc 918 from node 702 in FIG. 7 (node 902 in FIG. 9) to node 802 in FIG. 8 (node 904 in FIG. 9) in accordance with the second technique described above for joining two constituent Bayesian Belief Networks.

In a more realistic example (not shown) of a combined Bayesian Belief Network that represents the three example data sets referred to above, the combined Bayesian Belief Network topology may include upward of 25 nodes and dozens of arcs.

In some embodiments, the workspace provided by the Tetrad IV software may be used, via the graphical user interface provided by the workspace, to cut-and-paste one network into another. In addition or alternatively, the workspace may be used to copy one graph by eye and hand (e.g., by referring to hard copy) into the workspace while the second graph is displayed, with suitable connections/overlaps between the graphs being indicated in the user input into the workspace.

The underlying data sets may be cut-and-pasted together into the software.

At 406 in FIG. 4, the user may generate a parametric model based on the topology of the combined Bayesian Belief Network formed at 404. Then, at 408, the user may use the instantiated models for the constituent Bayesian Belief Network to generate an instantiated model that corresponds to the combined Bayesian Belief Network.

The instantiated model that results from step 408, based on the combined Bayesian Belief Network, may be considered to represent a virtual data set that encompasses the three data sets that were represented by the constituent Bayesian Belief Networks. Thus the combined Bayesian Belief Network and its corresponding instantiated model may effectively represent statistical properties of the combined variables of the three data sets, even though it would be difficult or impossible to form a single data set from the three data sets in view of inconsistencies in format among the three data sets.

The combined Bayesian Belief Network may provide other advantages as well. For instance, the probabilities expressed in the instantiated model for the combined Bayesian Belief Network may be easily updated to reflect additional or updated data. The combined Bayesian Belief Network may also simplify reasoning about statistical dependence and independence among the variables.

Further, by using statistical independence, computational complexity may be reduced. The required sample size may be dependent on the complexity of the largest dependent set of variables. The combined Bayesian Belief Network also facilitates reasoning about uncertainties related to the data, and conditional probability distributions can be computed quickly. Moreover, the combined Bayesian Belief Network can aid in handling missing data and can provide a framework for discussing causality.

Referring again to FIG. 4, after the combined Bayesian Belief Network has been formed and the instantiated model thereof created, research or predictive exercises may be performed with the instantiated model to simulate analysis of the virtual data set represented by the combined Bayesian Belief Network. Simulation of the virtual data set from the combined Bayesian Belief Network is indicated in phantom at 410 in the flow chart shown in FIG. 4. In some embodiments, the instantiated model for the combined Bayesian Belief Network may be employed to recommend decisions with respect to insurance policies for drivers or groups of drivers. For instance, data collected with respect to one driver or a group of drivers may be processed with the instantiated combined model to produce a score. Based on the score, an insurance policy underwriting decision may be made in regard to the driver or group of drivers. The insurance policy may be for a motor vehicle fleet or an individual driver, and may be a collision or liability policy. The decisions with respect to the insurance policies may include one or more of: (a) whether to underwrite the policy; (b) setting of premium rates for the policy; (c) whether to renew the policy; and (d) whether to change the terms of the policy.

Up to this point, the inventive concept of combining Bayesian Belief Networks to represent a virtual combined data set has been illustrated with respect to data sets related to driver behavior and/or driving records. However, the inventive concept is potentially much more widely applicable and may be employed to virtually combine many other types of data sets, either within or outside of the financial services industry. For example, the inventive concept may be applied to data sets relating to insurance claim handling applications, insurance or non-insurance customer service operations including call centers, and marketing call centers or other marketing operations. Other industries in which the inventive concept may be applied may include the medical industry, social science research, and the transportation industry. In short, the inventive concept is broadly applicable to any endeavor that may entail a desire to consider together two or more large, inconsistently formatted data sets.

In addition to the aforementioned underwriting applications, the methods and systems described herein are further well suited for the processing and handling of any number of insurance related actions and/or requests by an insurance/financial services company, insurance customer and/or insurance agent. Such actions/requests may take the form of receiving a request for and providing an insurance quote, issuing a new insurance policy, receiving a request for and providing additional coverage(s), processing policy modifications such as changing deductibles, exclusions and/or liability limits, offering coverage recommendations, denying or cancelling coverage(s) and policies, implementing coverage discounts or the processing and handling policy renewals. As used herein, the insurance customer may be an individual seeking personal lines insurance (e.g., life insurance, homeowners/renters insurance, automobile insurance and umbrella insurance) or a business seeking commercial insurance coverage (e.g., property and casualty insurance, umbrella insurance policies, directors and officers insurance etc.), medical insurance, group benefit type insurance and/or workers compensation insurance among others.

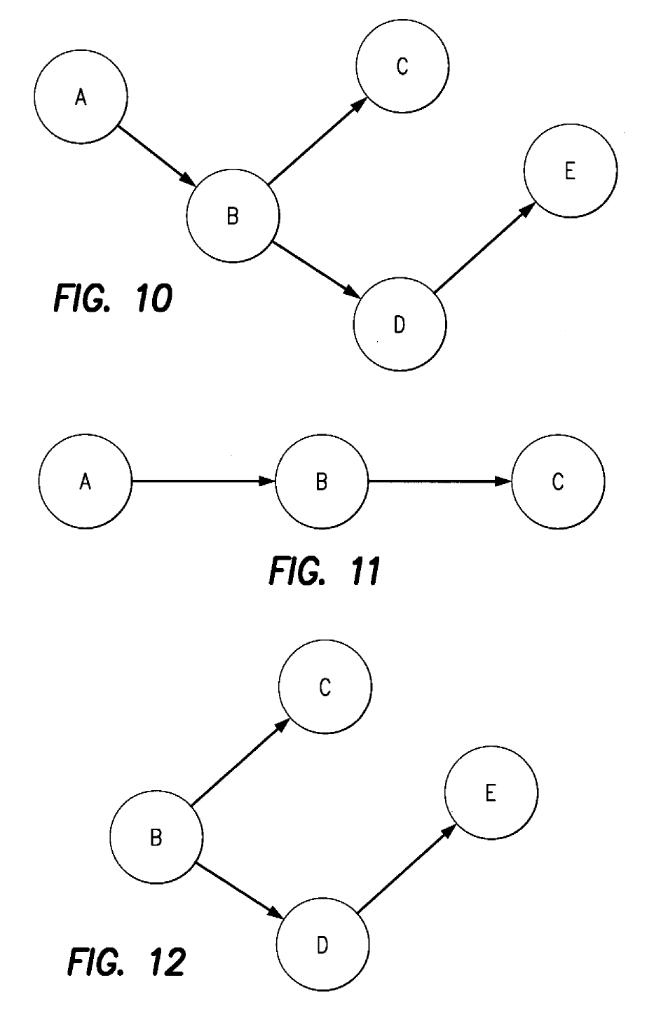

To elaborate on the earlier discussion of producing combined Bayesian Belief Networks, further techniques that may be useful for such purposes will now be described, with reference in some respects to FIGS. 10-14. As noted above, FIGS. 10-14 are simulated example Bayesian Belief Networks that are useful for illustrating example techniques for producing combined Bayesian Belief Networks in accordance with aspects of the present invention.

One useful determination to be made in producing a combined Bayesian Belief Network from two or more constituent Bayesian Belief Networks is an assessment of what variables represented in the constituent Bayesian Belief Networks are important. For example, in connection with an insurance decision, the variable or variables that are useful for estimating likely claim frequency or severity may be the important variables. Other important variables may be the variables that are dependent upon the variables referred to in the previous sentence, or that the variables in the previous sentence are dependent on.

For example, and referring now to FIG. 10, suppose that variable B is the variable to be predicted (e.g., B may represent claim frequency). In this case, B is referred to as the response variable. In such a case, and continuing to refer to FIG. 10, the important variables are A, C and D but not E. More specifically, the important variables may be A alone, or the pair C and D. It may not be necessary to have all three as important variables because every Bayesian Belief Network is equivalent to another Bayesian Belief Network which has all edges reversed as compared to the first Bayesian Belief Network. Accordingly, the important variables may be taken to be either the parent(s) or the child(ren) of the response variable.

As a side note to FIG. 10 and also FIGS. 11-14, it should be understood that each variable (node) represented therein may in some cases represent a group of variables.

Another aspect of producing a combined Bayesian Belief Network includes determining how to connect the constituent graphs (i.e., the constituent Bayesian Belief Networks; those skilled in the art will be aware that Bayesian Belief Networks are a type of directed acyclic graph).

In regard to connecting the constituent graphs there are three cases, with two options for each case. The two options consist in either using the parent(s) or the child(ren) of the response variable as the set of important variables.

In the first of the three cases, there is no overlap among the important variables in the constituent graphs. In this case, aspects of the present invention call for drawing edges between the important variables of the first graph and any node in the second graph that either depends on the important variables in the second graph, or upon which the important variables in the second graph are dependent. If one is using the option with respect to the children of the response variable, then the edges are to be drawn from the response variable and the children of the response variable of the first graph to the relevant variables in the second graph. If using parents of the response variable, edges are to be drawn from the relevant variables in the second graph to the response variable and parents of the response variable in the first graph.

It may be necessary to discover the relevant variables in the second graph and their relationship to the important variables by techniques that are external to the generation of the constituent graphs and to the constituent data sets. For example, the relationships to be represented by the edges to be drawn may be based on expert human judgment, by past research, or from data from additional studies or experiments. In addition or alternatively, the discovery of the relationships may be facilitated by the discovered topology of the second graph.

In the second of the three cases, there is complete overlap between the important variables in the two graphs.

This may be considered the easiest of the three cases because relationships are given in both graphs and a potentially distinct set of relationships to important variables is defined by each graph. In this case, the differences between the two graphs can be reconciled by creating a (combined) graph containing only the union of the important variables defined by the first graph, important variables defined by the second graph, and the response variable. The corresponding data set is simply one dataset appended to the other including only the important variables. Then, a new topology for the combined data set can be discovered by known techniques, such as by the above-described Tetrad IV software.

In the third of the three cases, there is partial overlap between the important variables.

For this case, the methods described in connection with the first two methods may be combined. That is, some relationships among the variables for the combined graph are given by the constituent graphs, whereas other relationships may need to be determined externally.

According to another aspect of the inventive method of producing a combined Bayesian Belief Network, the model is to be parameterized and instantiated.

Once the combined graph is connected (redrawn as connected) in the Tetrad software, the probabilities may be determined. The probabilities of the non-overlapping variables from the first graph may be derived in the usual manner using the Tetrad software or using external methods depending on the Tetrad software. It may be necessary to determine the probabilities of the new nodes (from the second graph) using a different method.

For edges to be determined without using the Tetrad software, the related probabilities may be determined by external techniques, as referred to above. For overlapping variables, the probabilities may be determined using the data and the Tetrad software by simply appending one data set to the other using only overlapping variables.

A more specific but simplified example will now be described with reference to FIGS. 11 and 12. Suppose first that there is a data set with variables A, B and C and another data set with variables B, C, D and E and that B is the variable to be estimated. For example, B may represent risk, or more specifically may represent the probability of claim frequency. Further suppose that the topology shown in FIG. 11 is developed for the first data set and that the topology shown in FIG. 12 is developed for the second data set.

It will be noted that variable C is in both data sets and has the same relationship (with B) in both sets. This implies that it would be easy to use C in both data sets, and in order to arrive at a combined dataset, the children of the response variable B, rather than the parents, may be used, with C chosen to be a child of B in the combined graph.

Next, it is necessary to determine the relationship between D and A and the relationship between E and A. If either D or E were parents of A in the combined topology, the graph would be cyclic, and hence a considerable number of other tests would be necessary. Since D is a direct child of B, then it can be said that D is important, and should be part of the connection, and adding an edge from D to A would provide no additional value.

In the second dataset, E is statistically independent of B given D, so regardless of its relationship to A, E is not needed in the combined graph.

In the example which comprises FIGS. 11 and 12 and the data sets they represent, there is enough overlap that no additional or external judgment, evidence or study is needed.

Finally with respect to this example, suppose that all variables are to be modeled as a multivariate Normal. In this case the probability of a claim (variable B) given the other variables would be expressed as:

$$\begin{matrix}f ( b \vert c , d ) = \frac{f ( b , c , d )}{f ( c , d )} \\ = \frac{exp [ - \frac{1}{2} {( 〈 b , c , d 〉 - {μ}_{b , c , d} )}^{t} {\sum }_{b , c , d}^{- 1} ( 〈 b , c , d 〉 - {μ}_{b , c , d} ) ]}{exp [ - \frac{1}{2} {( 〈 c , d 〉 - {μ}_{c , d} )}^{t} {\sum }_{c , d}^{- 1} ( 〈 c , d 〉 - {μ}_{c , d} ) ] {σ}_{b} \sqrt{2 π}} \\ = \frac{exp [ \begin{matrix}- \frac{1}{2} {( 〈 b , c , d 〉 - {μ}_{b , c , d} )}^{t} {\sum }_{b , c , d}^{- 1} ( 〈 b , c , d 〉 - {μ}_{b , c , d} ) + \\ \frac{1}{2} {( 〈 c , d 〉 - {μ}_{c , d} )}^{t} {\sum }_{c , d}^{- 1} ( 〈 c , d 〉 - {μ}_{c , d} )\end{matrix} ]}{{σ}_{b} \sqrt{2 π}}\end{matrix} \qquad ( Eq . 1 )$$

In the above Equation 1, <b,c,d> is a vector of values for variables B, C and D; μ_{b,c,d} is the mean vector for variables B, C and D; Σ⁻¹_{b,c,d} is the variance-covariance matrix of variables B, C, and D and σ_{b} is the variance of B.

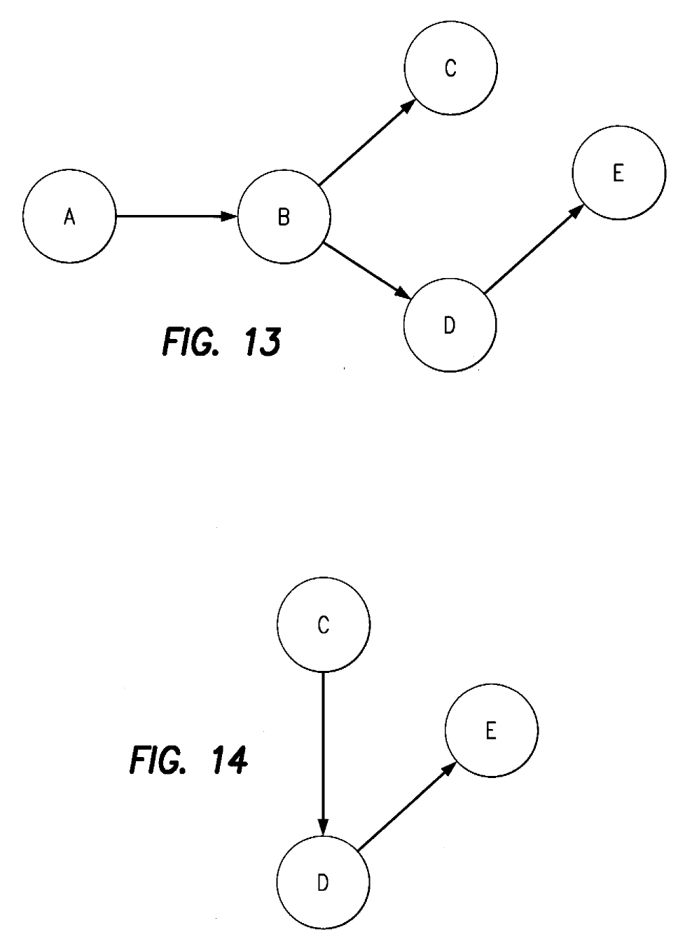

The variance of B may be obtained by combining the values of B from both data sets. The covariance of B and C may be obtained by using a data set of B and C from both data sets and the covariance of B and D is from the second data set. The combined topology may be as indicated in FIG. 13.

It should be noted that there may be other edges in a full data set but since it is only desired to estimate B, the graph shown in FIG. 13 includes all the edges that are relevant. Thus, it may be concluded that the best estimate of B may be obtained by using only C and D.

The variable that is to be estimated (i.e., the response variable) may in some cases not be in every data set. This presents challenges not present in the above example. To represent this case, the above example may be changed by supposing that the second data set contains only variables C, D and E and has the topology illustrated in FIG. 14.

In this example, it may be necessary to determine the relationship between C and B, between D and B, and between E and B. Informed judgment, additional research, further data or some combination of these may be used to determine these relationships. Also, it would be possible to look for the relationships between these variables and A.

Turning from these examples, there will now be a discussion of various techniques by which data sets may be combined, thereby illustrating comparisons and contrasts with the techniques that are the subject of this disclosure.

A number of different methods of combining data are known, including methods that retain all the desired statistical properties. An example of a common method of combining two data sets (of say n and m observations each), is to create a data set of size n+m with all variables that were defined in either the first or the second set defined for each observation in the new combined data set. Thereafter, a value for a variable in the new data set may be imputed if that variable was not originally defined for that observation in the original data set.

The adequacy of this method depends on the method of imputation. A common method of imputation is to take averages of the variable over the observations where it is defined and use the average in places where it is not defined. However, this method is not at all robust, and is implemented only to prevent software failure. This method (unlike the technique that is the subject of this disclosure) does not provide any statistical combination.

Other, less common but more robust methods of imputation use other variables that are defined. One example would be to estimate the undefined (missing) values using regression on all of the other values that are defined in both sets. This result may at best produce results that are of similar effectiveness relative to the technique that is the subject of the present disclosure.

If all of the overlapping variables were used to make the estimate (imputation) of the undefined variables, then the estimate would likely have higher error than the technique of the present disclosure. There may generally be too much noise with this approach to imputation, because too many variables are taken into consideration.

Another very common approach to combining statistical data representations is simply to use covariance as an estimate. For example, suppose the means of three variables A, B, C are known. Further suppose that the covariance between A and B and the covariance between B and C are also known. A simple way to model the three variables if B is the variable of interest is to assume that A and C are independent. Thus if B is to be estimated, one can take the average of the estimate of B given A and of B given C.

The discussion will now turn to the subject of statistical independence as it pertains to Bayesian Belief Networks.

Much of the usefulness of Bayesian Belief Networks derives from the implication of statistical independence. Formally, statistical independence is defined in the following statement:

P(X|Z) [symbol] P(Y|Z) [symbol] P(X,Y|Z)=P(X|Z)P(Y|Z) (Eq. 2)

This statement may be read as follows: “The probability of X given Z is statistically independent of the probability of Y given Z if the probability of X and Y given Z equals the probability of X given Z times the probability of Y given Z.”

Alternatively, statistical independence can be defined in accordance with the following statement.

P(X|Z) [symbol] P(Y|Z) [symbol] P(Y|X,Z)=P(Y|Z)&P(X|Y,Z)=P(X|Z) (Eq. 3)

This statement may be read as follows: “The probability of X given Z is statistically independent of the probability of Y given Z if the probability of Y given X and Z equals the probability of Y given Z and the probability of X given Y and Z equals the probability of X given Z.

If a model is using multivariate Normal distributions to model the variables, then a reasonable test of independence would be:

|f(b|c)−f(b|c,d)<ε (Eq. 4)

where ε is a very small number such as 0.01 and

$$f ( b \vert c ) - f ( b \vert c , d ) = \frac{exp [ - \frac{1}{2} {( 〈 b , c 〉 - {μ}_{b , c} )}^{t} {\sum }_{b , c , d}^{- 1} ( 〈 b , c 〉 - {μ}_{b , c} ) + {( \frac{c - {μ}_{c}}{2} )}^{2} ]}{{σ}_{b} \sqrt{2 π}} - \frac{exp [ \begin{matrix}- \frac{1}{2} {( 〈 b , c , d 〉 - {μ}_{b , c , d} )}^{t} {\sum }_{b , c , d}^{- 1} ( 〈 b , c , d 〉 - {μ}_{b , c , d} ) + \\ \frac{1}{2} {( 〈 c , d 〉 - {μ}_{c , d} )}^{t} {\sum }_{c , d}^{- 1} ( 〈 c , d 〉 - {μ}_{c , d} )\end{matrix} ]}{{σ}_{b} \sqrt{2 π}} \qquad ( Eq . 5 )$$

Apart from the above-noted advantages of representing a “virtual” combined data set with a combined Bayesian Belief Network, there are further advantages that may be realized by using Bayesian Belief Networks to represent large quantities of data. For example, in connection with operations that generate a great deal of data, the data may be periodically represented by a Bayesian Belief Network, and then the Bayesian Belief Network may be stored in a data management system. Quantities of data on the order of petabytes may be effectively represented by Bayesian Belief Networks that may collectively take up less than a few megabytes of memory storage space.

To make this example more specific, suppose there is an operation that generates 100 gigabytes of data every month. At the end of the month, the data could be represented by a Bayesian Belief Network. Then the underlying data could be deleted or stored using much less expensive storage devices that provide less ready access to the data.

In accordance with this example, one terabyte of data is represented by 10 Bayesian Belief Networks. Then, if the variable definitions are the same for every month, the 10 Bayesian Belief Networks may be combined in a straightforward manner. Even if the variable definitions were changed over time, the 10 Bayesian Belief Networks per terabyte of data would still take up much less memory than the data itself.

Continuing with this example, if a research organization wishes to perform research on the terabyte of data, it could do so by using the final combined Bayesian Belief Network. Alternatively, the Bayesian Belief Network could be used to create a representative data set of arbitrary size if the researcher preferred to use a data set rather than the Bayesian Belief Network. Such a research approach (working with the Bayesian Belief Network) may allow research that is conventionally performed on petabytes of data to be performed virtually on Bayesian Belief Networks derived from the petabytes of data but with much less need for storage space, at much lower cost, and with much more rapid access to the information as represented by the Bayesian Belief Networks.

In examples disclosed above, it will be recognized that Bayesian Belief Networks serve as graphical representations of the underlying data sets or virtual data sets. The teachings of this disclosure may also be applicable to graphical representations of data other than Bayesian Belief Networks. Thus, it is contemplated in accordance with teachings herein to combine graphical representations other than Bayesian Belief Networks to form combined graphical representations that represent virtual data sets.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for generating a suggested insurance decision, the method comprising:
storing a first data set in a computer, said first data set containing data related to public driving record information;
storing a second set of data in the computer, said second data set containing data gathered telematically with respect to a first plurality of drivers, said second data set having a different format from said first data set;
processing the first data set with the computer to generate a first Bayesian Belief Network that represents the first data set;
processing the second data set with the computer to generate a second Bayesian Belief Network that represents the second data set;
combining the first and second Bayesian Belief Networks to form a combined Bayesian Belief Network that represents a virtual data set, said virtual data set encompassing at least a portion of each of said first and second data sets;
receiving input with respect to a proposed or current insured; and
generating a signal indicative of a suggested insurance decision with respect to the proposed or current insured, based at least in part on (a) the received input with respect to the proposed or current insured and (b) the combined Bayesian Belief Network.

2. The method of claim 1, wherein:
the first data set is received from a first source; and
the second data set is received from a second source different from the first source.

3. The method of claim 2, wherein:
the input with respect to the proposed or current insured is received from the first and second sources.

4. The method of claim 3, wherein the proposed or current insured is an individual motor vehicle owner.

5. The method of claim 3, wherein the proposed or current insured is an organization that operates a fleet of motor vehicles.

6. The method of claim 1, wherein the insurance decision relates to at least one of underwriting an insurance policy, offering an insurance policy, renewing an insurance policy, adjusting an insurance policy, and pricing an insurance policy.

7. The method of claim 1, further comprising:
storing a third data set in the computer, said third data set containing data gathered telematically with respect to a second plurality of drivers, said second plurality of drivers at least partially different from said first plurality of drivers, said third data set having a different format from each of said first and second data sets; and
processing the third data set with the computer to generate a third Bayesian Belief Network that represents the third data set;
wherein the third Bayesian Belief Network is combined with the first and second Bayesian Belief Networks to form the combined Bayesian Belief Network.

8. The method of claim 1, wherein the suggested insurance decision concerns a motor vehicle collision insurance policy.

9. The method of claim 1, wherein the suggested insurance decision concerns a motor vehicle liability insurance policy.

10. The method of claim 1, wherein:
the first data set includes at least one variable that is not included in the second data set.

11. The method of claim 1, wherein:
combining the first and second Bayesian Belief Networks includes linking the first and second Bayesian Belief Networks via at least one variable that is common to the first and second data sets.

12. The method of claim 1, wherein:
combining the first and second Bayesian Belief Networks includes connecting a node in the first Bayesian Belief Network with a node in the second Bayesian Belief Network.

13. The method of claim 1, wherein:
combining the first and second Bayesian Belief Networks includes operating a graphical user interface on the computer to interconnect the first and second Bayesian Belief Networks.

14. A method comprising:
deriving a first Bayesian Belief Network from a first data set;
deriving a second Bayesian Belief Network from a second data set;
providing at least one link between the first and second Bayesian Belief Networks to generate a composite Bayesian Belief Network, said composite Bayesian Belief Network representing a virtual data set that encompasses at least a portion of each of the first and second data sets; and
storing the composite Bayesian Belief Network in a computer.

15. The method of claim 14, wherein:
deriving the first Bayesian Belief Network includes executing a computer program on the computer to discover from the first data set a topology of the first Bayesian Belief Network; and
deriving the second Bayesian Belief Network includes executing the computer program on the computer to discover from the second data set a topology of the second Bayesian Belief Network.

16. The method of claim 14, wherein providing the at least one link between the first and second Bayesian Belief Networks includes joining the first and second Bayesian Belief Networks at a node that is common to the first and second Bayesian Belief Networks.

17. The method of claim 14, wherein providing the at least one link between the first and second Bayesian Belief Networks includes drawing an arc from a first node included in the first Bayesian Belief Network to a second node included in the second Bayesian Belief Network.

18. A computer system for generating a suggested insurance decision, the computer system comprising:
a processor; and
a memory in communication with the processor and storing program instructions, the processor operative with the program instructions to:
store a first data set in a computer, said first data set containing data related to public driving record information;
store a second set of data in the computer, said second data set containing data gathered telematically with respect to a first plurality of drivers, said second data set having a different format from said first data set;
process the first data set with the computer to generate a first Bayesian Belief Network that represents the first data set;
process the second data set with the computer to generate a second Bayesian Belief Network that represents the second data set;
combine the first and second Bayesian Belief Networks to form a combined Bayesian Belief Network that represents a virtual data set, said virtual data set encompassing at least a portion of each of said first and second data sets;
receive input with respect to a proposed or current insured; and
generate a signal indicative of a suggested insurance decision with respect to the proposed or current insured, based at least in part on (a) the received input with respect to the proposed or current insured and (b) the combined Bayesian Belief Network.

19. A method for generating a suggested insurance decision, the method comprising:
storing a first data set in a computer, said first data set containing data related to public driving record information;
storing a second set of data in the computer, said second data set containing data gathered telematically with respect to a first plurality of drivers, said second data set having a different format from said first data set;
processing the first data set with the computer to generate a first graphical representation that indicates statistical independence relationships among variables in the first data set;
processing the second data set with the computer to generate a second graphical representation that indicates statistical independence relationships among variables in the second data set;
combining the first and second graphical representations to form a third graphical representation that combines at least a portion of the first graphical representation with at least a portion of the second graphical representation;
receiving input with respect to a proposed or current insured; and
generating a signal indicative of a suggested insurance decision with respect to the proposed or current insured, based at least in part on (a) the received input with respect to the proposed or current insured and (b) the third graphical representation.

20. The method of claim 19, wherein:
the first data set is received from a first source; and
the second data set is received from a second source different from the first source.

21. The method of claim 19, wherein the insurance decision relates to at least one of underwriting an insurance policy, offering an insurance policy, renewing an insurance policy, adjusting an insurance policy, and pricing an insurance policy.
